(19) United States
(12) Patent Application Publication
(10) Pub. No.: US 2025/0381864 A1
(43) Pub. Date: Dec. 18, 2025

(54) ADAPTER AND CHARGING SYSTEM

(71) Applicant: HON HAI PRECISION INDUSTRY CO., LTD., New Taipei (TW)

(72) Inventors: Chih-Cheng Lee, New Taipei (TW); Jyun-Lin Jiang, New Taipei (TW); Chih-Te Hung, New Taipei (TW); Chiung-Hsiang Wu, New Taipei (TW); Yu-Cheng Zhang, New Taipei (TW); Yi-Lun Wei, New Taipei (TW); Chen-Ting Kao, New Taipei (TW); Sheng-Li Yen, New Taipei (TW); Chung-Wei Lu, New Taipei (TW); Chen Chao, New Taipei (TW); Cheng-Hung Chen, New Taipei (TW); Chi-Lin Wu, New Taipei (TW)

(21) Appl. No.: 19/011,856

(22) Filed: Jan. 7, 2025

(30) Foreign Application Priority Data
Jun. 17, 2024 (CN) 202410779995.X

(51) Int. Cl. B60L 53/16; H01R 13/627; H01R 31/06

(52) U.S. Cl. CPC B60L 53/16; H01R 13/6275; H01R 31/06

(57) ABSTRACT

An adapter and a charging system, the adapter includes a housing and a base locking device. The housing is provided with a mounting cavity. The base locking device includes a base locking member and a movable assembly. The base locking member is movably coupled to the housing, and the base locking member has a first locking position capable of locking to the base, and a first unlocking position capable of unlocking from the base. The movable assembly is movably disposed in the housing, the movable assembly capable of engaging the base locking member to limit the base locking member to the first locking position. The movable assembly is able to move away from the base locking member when the charging gun is extended into the mounting cavity, driven by the charging gun, to allow the base locking member to switch from the first locked position to the first unlocking position.

### FIELD

The subject matter relates to the technical field of charging adapter devices, and in particular to an adapter and charging system.

### BACKGROUND

Due to the mismatch between the charging gun and the charging interface of the vehicle. The related art provided a charging system includes an adapter, the adapter is used to connect the charging gun and the charging interface, respectively.

However, adapters in related technologies can be easily lost.

### SUMMARY

The present application provides an adapter and charging system to solve the problem of how to reduce the risk of losing adapters.

According to an aspect of the present application, there is provided an adapter includes a housing and a base locking device. The housing is provided with a mounting cavity, the mounting cavity is used to mount a charging gun. The base locking device includes a base locking member and a movable assembly. The base locking member is movably coupled to the housing, and the base locking member has a first locking position capable of locking to a base and a first unlocking position capable of unlocking from the base. The movable assembly is movably disposed in the housing, the movable assembly is capable of engaging the base locking member to restrict the base locking member to the first locking position. The movable assembly is constructed to be able to move away from the base locking member when the charging gun is extended into the mounting cavity, driven by the charging gun, to allow the base locking member to switch from the first locking position to the first unlocking position.

With the above described adapter, since the base locking member is provided for locking the adapter to the base in the first locking position and can only be switched to the first unlocking position to unlock the adapter from the base after the charging gun has been extended into the mounting cavity, the base locking member is maintained in the first locking position when the charging gun has not been extended into the mounting cavity, reducing the risk of loss of the adapter.

In one embodiment, the base locking member is rotationally coupled to the housing

about the first axis of rotation, the base locking member has a first end and a second end disposed on each side of the first axis of rotation, the first end for locking the base. The movable assembly includes a bracket, a first resilient member, and a stop member. The bracket is movably disposed through the housing in a first direction, and an end of the bracket proximate the mounting cavity in the first direction is capable of extending into the mounting cavity. The first resilient member resiliently presses against the bracket to exert a resilient force on the bracket in the first direction toward the mounting cavity. A stop member is movably disposed in the housing along the second direction, one end of the stop member along the second direction is movably coupled to the bracket, and the other end of the stop member along the second direction is capable of extending between the second end and the housing and against the second end to limit the base locking member in the first locking position; the second direction is disposed at an angle to the first direction. The bracket is constructed to be able to move in the first direction towards a side away from the mounting cavity when the charging gun is extended into the mounting cavity, driven by the charging gun, and to be able to drive the stop member away from the base locking member in the second direction, thereby allowing the base locking member to rotate about the first rotation axis relative to the housing, and thus being able to switch from the first locked position to the first unlocking position.

In one embodiment, the stop member is provided with a first groove, the first groove has a third end and a fourth end that are back-to-back in an extension direction thereof, the third end is disposed between the fourth end and the mounting cavity along the first direction, and the fourth end is disposed between the third end and the second end along the second direction. The stop member is coupled to the first groove along the second direction away from the second end and is capable of moving within the first groove along the direction of extension of the first groove. The stop member is constructed to be capable of moving from the fourth end to the third end, driven by the bracket, to move away from the base locking member along the second direction when the bracket is moved in the first direction toward a side away from the mounting cavity.

In one embodiment, the mounting cavity extends in a second direction and through one end of the housing to form an opening. The first end is disposed proximate the end of the housing away from the opening. The first axis of rotation, the first direction and the second direction are both perpendicular.

In one embodiment, the adapter further includes a charging gun locking device. The charging gun locking device is movably disposed in the housing, and the charging gun locking device has a second locking position capable of locking the charging gun within the mounting cavity, and a second unlocking position capable of unlocking the charging gun from the mounting cavity. The charging gun locking device is constructed to be capable of switching from the second locking position to the second unlocking position when the base is connected to the adapter.

In one embodiment, the base is provided with a butt joint. The charging gun locking device includes a charging gun locking member, a second resilient member, and a movable member.

The charging gun locking member is movably disposed through the housing in a first direction, and in a second locking position, an end of the charging gun locking member near the mounting cavity in the first direction is able to extend into the mounting cavity to lock the charging gun in the mounting cavity. The second resilient member resiliently presses against the charging gun locking member to exert a resilient force on the charging gun locking member along the first direction toward the mounting cavity. The movable member is movably disposed in the housing along the second direction, one end of the movable member along the second direction is movably coupled to the charging gun locking member, and the other end of the movable member along the second direction is capable of abutting against the abutment member. The movable member is constructed to be capable of being moved in the second direction toward a side proximate to the charging gun locking member when the base is connected to the adapter, driven by the butt joint in the second direction, and capable of driving the charging gun locking member in the first direction toward a side away from the mounting cavity, thereby switching the charging gun locking member from the second locking position to the second unlocking position.

In one embodiment, the charging gun locking member is provided with a second groove on a portion of the charging gun locking member disposed outside of the mounting cavity, the second groove having a fifth end and a sixth end opposite each other along the second direction, the sixth end is disposed between the end of the movable member away from the charging gun locking member and the fifth end along the second direction; the second groove has a cross-section that gradually increases in size perpendicular to the second direction from the fifth end to the sixth end. The end of the movable member proximate the charging gun locking member along the second direction is movably disposed through the second groove and is constructed to fit into the second groove. The movable member is constructed to be capable of switching the charging gun locking member from the second locking position to the second unlocking position by the butt joint driving the end of the movable member threaded in the second groove toward the side proximate to the fifth end to drive the charging gun locking member in the first direction toward the side away from the mounting cavity when the base is coupled to the adapter.

In one embodiment, the charging gun is provided with a snap-in slot. In the second locking position, the charging gun locking member is constructed to be able to extend into the snap-in slot to lock the charging gun in the mounting cavity.

In one embodiment, the mounting cavity extends in the second direction and through one end of the housing to form an opening. The end of the housing along the second direction away from the opening is provided with a connecting portion, the connecting portion is used to connect to the base. The end of the movable member away from the charging gun locking member is provided near to the connection portion.

According to another aspect of the present application, there is provided a charging system includes a charging gun, a base, and an adapter of any of the above embodiments.

### BRIEF DESCRIPTION OF THE DRAWINGS

FIG. 1 shows a schematic view of a structure of an embodiment of a charging system according to the present disclosure.

FIG. 2 shows a schematic view of an assembled state of a base and an adapter shown in FIG. 1.

FIG. 3 shows a schematic view of a structure of an adapter shown in FIG. 1.

FIG. 4 shows a cross-sectional view of an adapter shown in FIG. 1, while a base locking member in a first locked position, and a charging gun locking device is in a second unlocking position.

FIG. 5 shows a cross-sectional view of an adapter shown in FIG. 1, while a base locking member in a first unlocking position, and a charging gun locking device in a second locked position.

FIG. 6 shows a schematic view of a structure of a movable assembly shown in FIG. 1, while a base locking member in a first locking position.

FIG. 7 shows a schematic view of a base, an adapter and a charging gun shown in FIG. 1.

FIG. 8 shows a schematic view of a structure of a charging gun locking device shown in FIG. 1, while the charging gun locking device is in a second locking position.

FIG. 9 shows a schematic view of the structure of a charging gun locking device shown in FIG. 1, while the charging gun locking device is in a second unlocking position.

FIG. 10 shows a schematic view of the structure of a charging gun locking device viewed from another prospective shown in FIG. 1.

FIG. 11 shows a schematic diagram of a structure of a charging gun shown in FIG. 1.

### DETAILED DESCRIPTION

The technical solutions in the embodiments of the present application will be described clearly and completely in the following in conjunction with the accompanying drawings in the embodiments of the present application, and it is clear that the described embodiments are only a part of the embodiments of the present application and not all of the embodiments.

It should be noted that when an element is the to be “fixed” to another element, it may be directly on the other element or there may also be a centered element. When an element is the to be “attached” to another element, it may be directly attached to the other element or there may be both centered elements. When an element is considered to be “set on” another element, it may be set directly on the other element or there may be both centered elements. The terms “vertical,” “horizontal,” “left,” “right,” and similar expressions are used herein for illustrative purposes only. are used herein for illustrative purposes only.

Unless otherwise defined, all technical and scientific terms used herein have the same meaning as commonly understood by those skilled in the art belonging to the field of this application. Terms used herein in the specification of this application are used only for the purpose of describing specific embodiments and are not intended to limit this application. The term “or/and” as used herein includes any and all combinations of one or more related listed items.

Some embodiments of the present application are described in detail. The following embodiments and features in the embodiments may be combined with each other without conflict.

### Example of Implementation

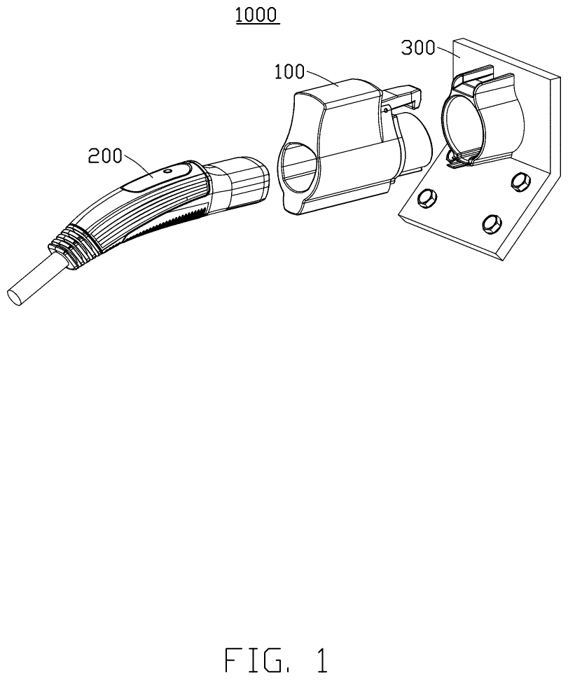

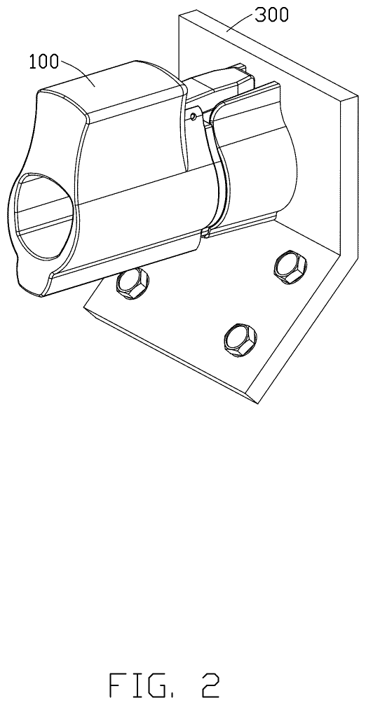

FIG. 1 shows a schematic view of the structure of a charging system 1000 in an embodiment of the present disclosure; and FIG. 2 shows a schematic view of the assembly state of a base 300 and an adapter 100 in the embodiment shown in FIG. 1.

Referring to FIG. 1, embodiments of the present disclosure provide a charging system 1000 for charging a vehicle. The vehicle is, for example, an electric vehicle, a plug-in hybrid vehicle, or the like. In some embodiments, the vehicle may also be an electric motorcycle or other vehicle that requires charging.

The charging system 1000 in this embodiment includes a charging gun 200, a base 300, and an adapter 100.

When the charging interface (not shown in the figure) of the vehicle with the charging gun 200 is of the same standard, the charging gun 200 can be directly employed to plug into the charging interface to charge the vehicle.

When the charging gun 200 has a different standard from the charging port of the vehicle, the adapter 100 can be connected to the charging gun 200 so that the charging gun 200 is connected to the charging port of the vehicle (not shown in the figure) via the adapter 100 to charge the vehicle. As shown in FIG. 2, when the adapter 100 is not in use, the adapter 100 is stored in the base 300.

In this way, when the adapter 100 is not used, the risk of losing the adapter 100 is reduced because the adapter 100 is stored in the base 300.

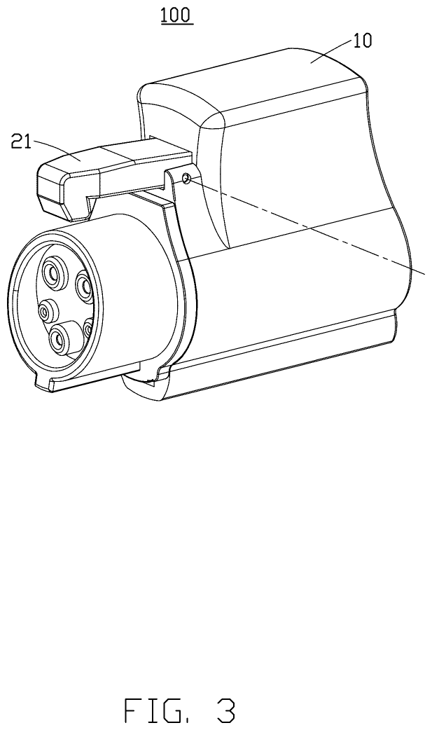

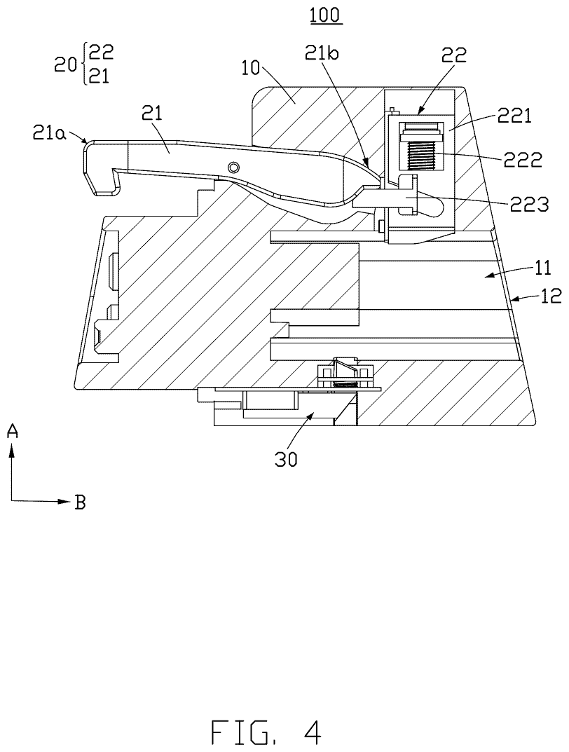

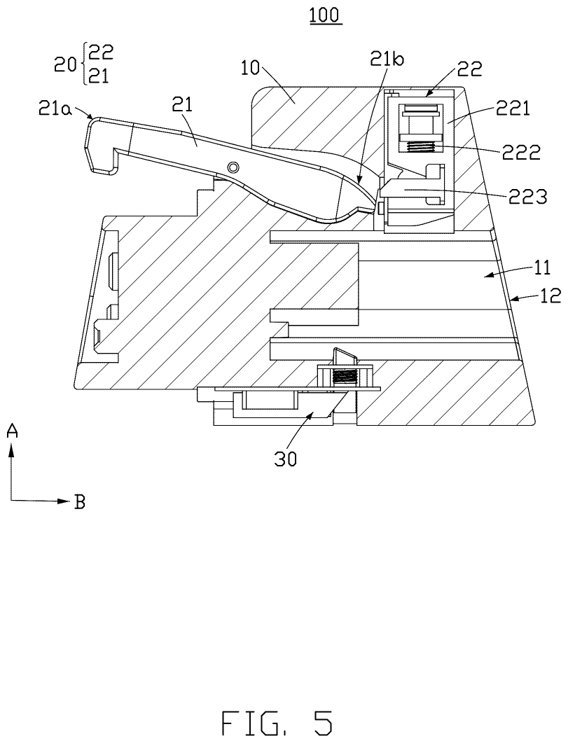

FIG. 3 shows a schematic view of the structure of the adapter 100; FIG. 4 shows a cross-sectional view of the adapter 100 while the base locking member 21 is in a first locking position and the charging gun locking device 30 in the second unlocking position; and FIG. 5 shows a cross-sectional view of the adapter 100 while the base locking member 21 is in the first unlocking position and the charging gun locking device 30 in the second locking position.

Referring to FIG. 3 to FIG. 5, this embodiment provides the adapter 100, the adapter 100 includes a housing 10 and a base locking device 20.

The housing 10 is provided with a mounting cavity 11, the mounting cavity 11 is used for mounting a charging gun 200 (see FIG. 1), the charging gun 200 can be plugged and mounted in the mounting cavity 11 when required. The base locking device 20 includes a base locking member 21 and a movable assembly 22. The base locking member 21 is movably coupled to the housing 10, the base locking member 21 has the first locking position capable of locking to a base 300 and a first unlocking position capable of unlocking from the base 300. The movable assembly 22 is movably disposed in the housing 10, the movable assembly 22 is capable of engaging the base locking member 21 to limit the base locking member 21 to the first locked position. The movable assembly 22 is constructed to be able to move away from the base locking member 21 as the charging gun 200 is driven by the charging gun 200, when the charging gun 200 is extended into the mounting cavity 11, to allow the base locking member 21 to switch from the first locking position to the first unlocking position.

With the above described adapter 100, when the charging gun 200 is not extended into the mounting cavity 11, the base locking member 21 is in the first locking position to allow the adapter 100 to be locked to the base 300, reducing the risk of loss of the adapter 100 when not in use. When the charging gun 200 is extended into the mounting cavity 11, the movable assembly 22 is driven by the charging gun 200 away from the base locking member 21 to allow the base locking member 21 to switch from the first locked position to the first unlocking position to enable the adapter 100 to be detached from the base 300, allowing the charging gun 200 to be connected to the charging port of the vehicle via the adapter 100 to charge the vehicle. For example, when the charging gun 200 has a different standard than the charging interface on the vehicle, connecting the charging gun 200 to the charging interface of the vehicle via the adapter 100 enables the charging gun 200 to be connected to and charged by a charging interface of another standard.

It should be noted that the related technology provides a base locking device which locks or unlocks the base with the adapter by means of an electronic design, so that the base locking device needs to be electrically powered in order to realize its function, and thus the base locking device in the related technology needs to be located in a location where there is a supply of electricity. In contrast, the adapter 100 provided in the above embodiment realizes locking and unlocking of the adapter 100 with the base 300 by means of a mechanical design, i.e., by extending the charging gun 200 into the mounting cavity 11 or removing the charging gun 200 from the mounting cavity 11 to realize the switching of the base locking member 21 between a first unlocking position and the first locking position, so that the base locking device 20 does not need to be energized to use the base locking device, and therefore reduces the number of limitations on the use scenarios of the adapter 100. Moreover, since only the charging gun 200 needs to be inserted and removed from the mounting cavity 11 when the above operation is performed, the operation of disassembling and assembling the base locking device 20 is reduced, and the convenience of using the adapter 100 is improved.

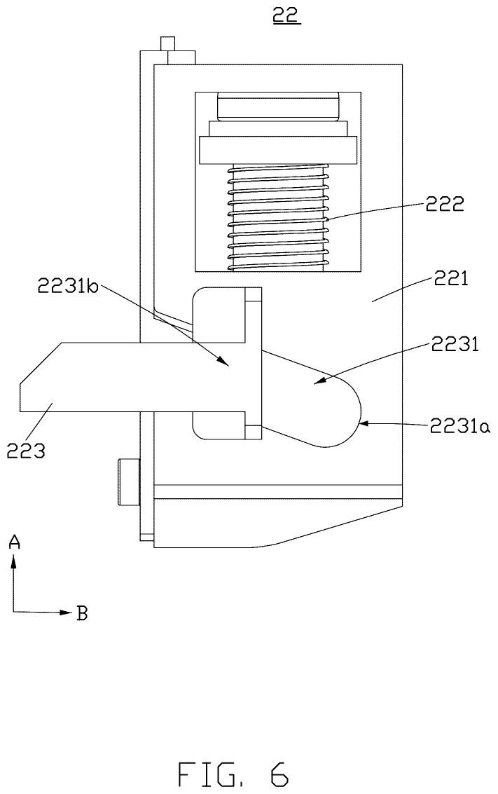

FIG. 6 shows a schematic structural view of the movable assembly 22 of the base locking member 21 in the first locking position.

In some embodiments, as shown in FIG. 4 and FIG. 5, the base locking member 21 is rotationally connected to the housing 10 about a first axis of rotation R, and the base locking member 21 has a first end 21a and a second end 21b disposed on each side of the first axis of rotation R, respectively, and the first end 21a is used to lock the base 300 (shown in FIG. 1). As shown in conjunction with FIG. 6, the movable assembly 22 includes a bracket 221, a first resilient member 222, and a stop member 223. The bracket 221 is movably disposed through the housing 10 along the first direction A. An end of the bracket 221 near the mounting cavity 11 along the first direction A is capable of extending into the mounting cavity 11, and the first resilient member 222 resiliently rests against the bracket 221 to exert an elastic force on the bracket 221 along the first direction A toward the mounting cavity 11. The stop member 223 is movably disposed in the housing 10 along the second direction B, one end of the stop member 223 along the second direction B is movably coupled to the bracket 221, and the other end of the stop member 223 along the second direction B is capable of extending between the second end 21b and the housing 10 and against the second end 21b to limit the base locking member 21 to the first locking position. The second direction B is provided at an angle to the first direction A. The bracket 221 is constructed to be able to move in the first direction A toward a side away from the mounting cavity 11 driven by the charging gun 200 when the charging gun 200 is extended into the mounting cavity 11, and to be able to drive the stop member 223 away from the base locking member 21 along the second direction B, thereby allowing the base locking member 21 to rotate about the first axis of rotation R with respect to the housing 10, and thus to be able to switch from the first locking position to the first unlocking position.

In use, when the charging gun 200 is extended into the mounting cavity 11, the charging gun 200 pushes the bracket 221 to move along the first direction A toward the side away from the mounting cavity 11, so that the bracket 221 drives the stop member 223 to move along the second direction B toward the side away from the base locking member 21, so that the stop member 223 leaves the second end 21b, thus allowing the second end 21b to rotate about the first axis of rotation R toward the side close to the stop member 223, and allowing the first end 21a to be able to rotate around the first axis of rotation R toward the side away from the stop member 223 to unlock the base 300 so that the adapter 100 can be separated from the base 300. When the charging gun 200 is removed from the mounting cavity 11, by the elastic force of the first resilient member 222, the bracket 221 moves along the first direction A toward the side near the mounting cavity 11, driving the stop member 223 to move along the second direction B toward the side near the base locking member 21, so that the stop member 223 extends between the second end 21b and the housing 10, thereby preventing the base locking member 21 from rotating about the first rotation axis toward the side near the base locking member 21, limiting the base locking member 21 to the first locking position.

Optionally, the base locking member 21 is a snap hook, which is used to hook the base 300. When in use, when the charging gun 200 is extended into the mounting cavity 11, the base locking member 21 is able to rotate around the first axis of rotation R relative to the housing 10, and at this time, it is possible to hook the base locking member 21 on the base 300; when the charging gun 200 is removed from the mounting cavity 11, the base locking member 21 is limited to the first locking position, and the base locking member 21 locks the adapter 100 with the base 300.

Optionally, the first resilient member 222 may be a torsion spring.

In some embodiments, as shown in FIG. 6, the stop member 223 is provided with a first groove 2231, the first groove 2231 has a third end 2231a and a fourth end 2231b that are back-to-back in their direction of extension, with the third end 2231a located between the fourth end 2231b and the mounting cavity 11 (shown in FIG. 5) along the first direction A. The fourth end 2231b located between the third end 223 la along the second direction B and between the second end 21b. The end of the stop member 223 that is remote from the second end 21b along the second direction B is coupled to the first groove 2231 and is capable of moving within the first groove 2231 along an extension of the first groove 2231. The stop member 223 is constructed to be able to move from the fourth end 2231b to the third end 2231a to leave the base locking member 21 along the second direction B, as the bracket 221 is moved along the first direction A toward the side away from the mounting cavity 11, driven by the bracket 221.

In some embodiments, as shown in FIG. 5, the mounting cavity 11 extends along the second direction B and through one end of the housing 10 to form an opening 12, the opening 12 is for passage of the charging gun 200. The first end 21a is provided close to the end of the housing 10 away from the opening 12, with the first axis of rotation R, the first direction A and the second direction B both are perpendicular. In this way, opposite ends of the housing 10 along the second direction B are made available for connecting the charging gun 200 and the base 300, respectively, to minimize the influence of the charging gun 200 and the base 300 on each other, and to make the charging gun 200 and the base 300 easy to be connected or detached from the adapter 100, respectively.

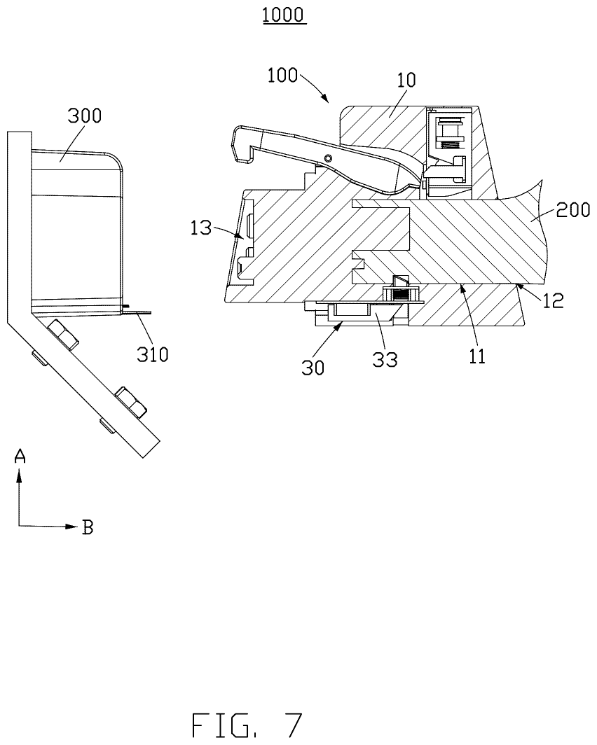

FIG. 7 shows a schematic view of the base 300, the adapter 100, and the charging gun 200.

In some embodiments, as shown in FIG. 4 and FIG. 5, the adapter 100 further includes a charging gun locking device 30, the charging gun locking device 30 is movably disposed in the housing 10, the charging gun locking device 30 has a second locking position capable of locking the charging gun 200 within the mounting cavity 11 (shown in FIG. 5), and a second unlocking position capable of unlocking the charging gun 200 from the mounting cavity 11 (shown in FIG. 4). In conjunction with FIG. 7, the charging gun locking device 30 is constructed to be capable of switching from the second locking position to the second unlocking position, when the base 300 is connected to the adapter 100. In this way, when the base 300 is not connected to the adapter 100, the charging gun locking device 30 locks the charging gun 200 in the mounting cavity 11, securing the charging gun 200 with respect to the adapter 100, so as to facilitate the connection of the charging gun 200 to the charging interface of the vehicle via the adapter 100. When the base 300 is connected to the adapter 100, the charging gun locking device 30 switches to a second unlocking position, unlocking the charging gun 200 from within the mounting cavity 11, so that the charging gun 200 can be detached from the adapter 100, storing the adapter 100 in the base 300.

It is to be understood that when the base 300 is connected to the adapter 100 and the charging gun 200 is not extended into the mounting cavity 11, the base locking member 21 is in a first locking position, locking the adapter 100 to the base 300; and it is when the charging gun 200 is extended into the mounting cavity 11 that the base 300 can be switched to the first unlocking position. And when the charging gun 200 is connected to the adapter 100 and the adapter 100 is not connected to the base 300, the charging gun locking device 30 is in the second locking position, locking the adapter 100 with the charging gun 200; and it is only when the adapter 100 is connected to the base 300 that the charging gun locking device 30 can be switched to the second unlocking position. Therefore, the adapter 100 must be connected to one of the base 300 and the adapter 100, and it is not possible to separate the adapter 100 from the base 300 and the charging gun 200 at the same time by human operation, so as to avoid the adapter 100 from being dislodged or stolen, and therefore reduce the risk of loss of the adapter 100. When not charged, the user may store the adapter 100 in the base 300 or the charging gun 200 of the usage habits.

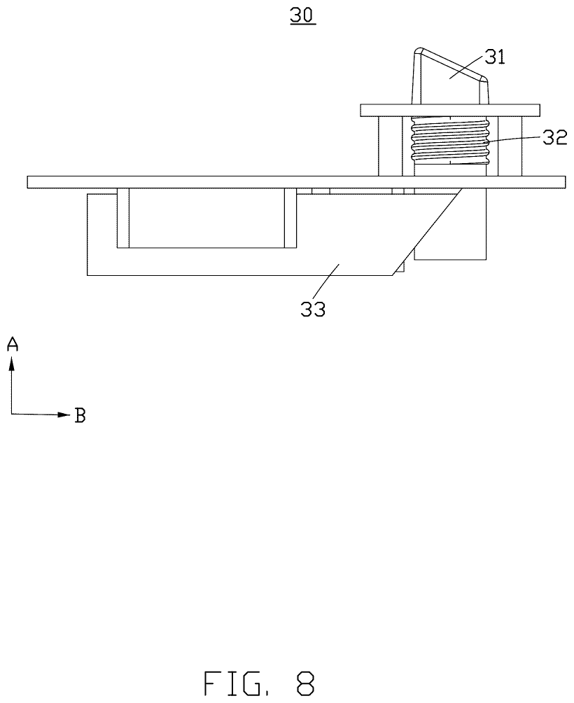

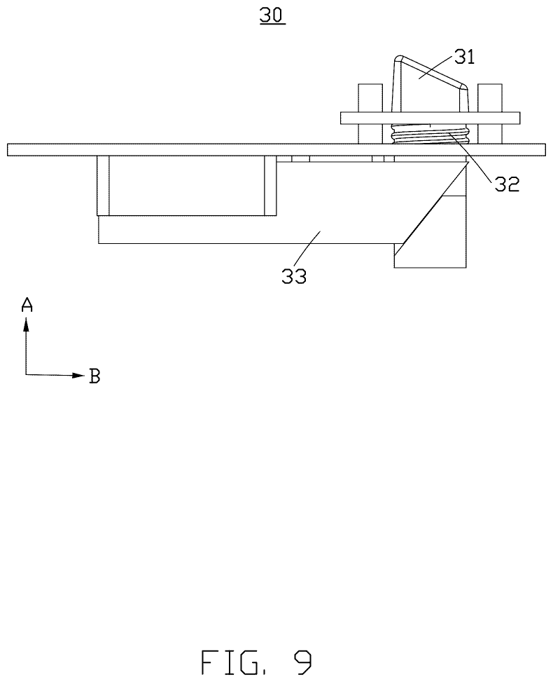

FIG. 8 shows a schematic view of the structure of the charging gun locking device 30 while it is in the second locked position; and FIG. 9 shows a schematic view of the structure of the charging gun locking device 30 while it is in the second unlocking position.

In some embodiments, as shown in FIG. 7, the base 300 is provided with an butt joint 310. As shown in FIG. 8 and FIG. 9, the charging gun locking device 30 includes a charging gun locking member 31, a second resilient member 32, and a movable member 33. The charging gun locking member 31 is movably disposed in the housing 10 along the first direction A, and in the second locking position, an end of the charging gun locking member 31 near the mounting cavity 11 along the first direction A is able to extend into the mounting cavity 11 to lock the charging gun 200 inside the mounting cavity 11. One end of the charging gun locking member 31 along the first direction A near the mounting cavity 11 is capable of extending into the mounting cavity 11 to lock the charging gun 200 in the mounting cavity 11. The second resilient member 32 resiliently presses against the charging gun locking member 31 to apply an elastic force to the charging gun locking member 31 along the first direction A toward the mounting cavity 11. The movable member 33 is movably disposed in the housing 10 along the second direction B. One end of the movable member 33 along the second direction B is movably coupled to the charging gun locking member 31, and the other end of the movable member 33 along the second direction B is capable of abutting against the butt joint 310. The movable member 33 is constructed to be able to move along the second direction B towards a side proximate to the charging gun locking member 31 when the base 300 is coupled to the adapter 100, driven by the butt joint 310, and to be able to drive the charging gun locking member 31 along the first direction A towards a side away from the mounting cavity 11, so as to switch the charging gun locking member 31 from the second locking position to the second unlocking position.

It is to be noted that, a charging gun locking device is provided in the related technology for securing a charging gun to an adapter, and the charging gun locking device is provided outside the adapter, and the charging gun locking device needs to be operated to lock or unlock the charging gun with the adapter when in use, resulting in inconvenience in mounting and dismounting the charging gun with the adapter. In contrast, in the above embodiment, the charging gun locking device 30 is switched between the second unlocking state and the second locking state through the attachment or detachment of the base 300 to the adapter 100, simplifying the operation of the adapter 100 when securing or detaching the adapter 100 from the charging gun 200, and improving the convenience of use.

Optionally, the second resilient member 32 may be a torsion spring.

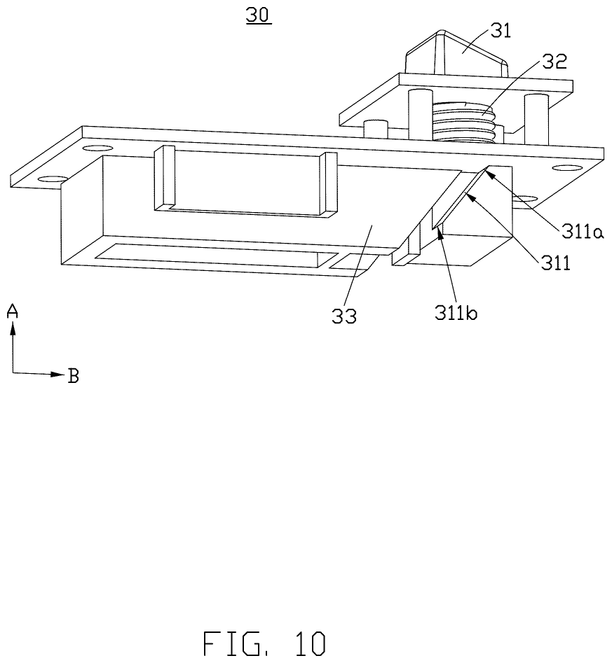

FIG. 10 shows a schematic view of the structure of the charging gun locking device 30 viewed from another prospective.

In some embodiments, as shown in FIG. 10, the charging gun locking member 31 is provided with a second groove 311 on a portion of the charging gun locking member 31 disposed outside of the mounting cavity 11, the second groove 311 has a fifth end 311a and a sixth end 311b that are opposite each other along the second direction B. Along the second direction B, the sixth end 311b is disposed between an end of the movable member 33 away from the charging gun locking member 31 and the fifth end 311a. From the fifth end 311a to the sixth end 311b, the size of the cross-section of the second groove 311 in perpendicular to the second direction B gradually increases. The movable member 33 is movably disposed along the second direction B proximate the end of the charging gun locking member 31 in the second groove 311 and is constructed to be adapted to fit into the second groove 311. The movable member 33 is constructed to be capable of moving the end of the movable member 33 threaded in the second groove 311 toward the side proximate the fifth end 311a, to move the charging gun locking member 31 along the first direction A toward the side away from the mounting cavity 11 when the base 300 is coupled to the adapter 100, thereby switching the charging gun locking member 31 from the second locked position to the second unlocking position.

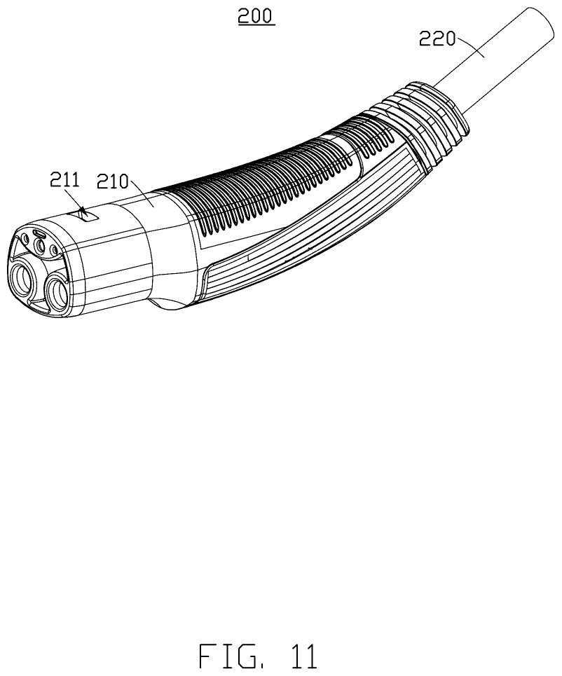

FIG. 11 shows a schematic diagram of the structure of the charging gun 200.

In some embodiments, the charging gun 200 is provided with a snap-in slot 211, as shown in FIG. 10. In conjunction with FIG. 7, the charging gun locking member 31 is constructed to be able to extend into the snap-in slot 211 to lock the charging gun 200 in the mounting cavity 11, in the second locking position.

When the adapter 100 is separated from the base 300 and the adapter 100 is connected to the charging gun 200, the charging gun locking member 31 is snapped to the snap-in slot 211 by the elastic force of the second resilient member 32 to prevent the charging gun 200 from being removed from the mounting cavity 11. When the adapter 100 is connected to the base 300, the butt joint 310 on the base 300 pushes the movable member 33 to move, and the movable member 33 drives the charging gun locking member 31 to move out of the v 211, so that the charging gun 200 can be removed from the mounting cavity 11. When it is necessary to remove the adapter 100 from the base 300, the charging gun 200 is extended into the mounting cavity 11, so that the base locking member 21 is unlocking from the base 300, and then the charging gun 200 and the adapter 100 are made to leave the base 300 together. When the movable member 33 is detached from the butt joint 310, by the action of the elastic force of the second resilient member 32, the charging gun locking member 31 is extended into the snap-in slot 211, and making charging gun 200 and adapter 100 locked.

Optionally, as shown in FIG. 11, the charging gun 200 includes a gun body 210 and a cable 220, with one end of the gun body 210 is connected to the cable 220, and the other end of the gun body 210 is used to access a charging port of the vehicle, or connected to the adapter 100, and accessed to the charging port of the vehicle via the adapter 100.

Specifically, the snap-in slot 211 is provided in the gun body 210.

In some embodiments, as shown in FIG. 7, the mounting cavity 11 extends along the second direction B and through one end of the housing 10 to form an opening 12, and the housing 10 is provided with a connecting portion 13 at an end of the housing 10 along the second direction B away from the opening 12, the connecting portion 13 is used to connect to the base 300 or the charging port of the vehicle. The end of the movable member 33 away from the charging gun locking member 31 is provided close to the connection portion 13. In this way, the opposite ends of the housing 10 along the second direction B are made to be used for connecting the charging gun 200 and the base 300, respectively, to minimize the influence of the charging gun 200 and the base 300 on each other, and to make it easy for the charging gun 200 and the base 300 to be connected or detached from the adapter 100, respectively.

Embodiments of the present application provide an adapter 100 in which the adapter 100 is stored in and locked with the base 300 when the adapter 100 is not in use. Prior to charging the vehicle using the charging gun 200 and the adapter 100, the charging gun 200 is extended into the mounting cavity 11 to switch the base locking member 21 from a first locking position to a first unlocking position, so that the adapter 100 can be separated from the base 300. In charging the vehicle using the charging gun 200 and the adapter 100, the adapter 100 is utilized to enable the charging gun 200 to be connected to and charged by the vehicle through the adapter 100, using a standard adaptation of the adapter 100 to the charging port of the vehicle. After charging the vehicle using the charging gun 200 and the adapter 100, the adapter 100 connected to the charging gun 200 is connected to the base 300, the base locking member 21 hooked to the base 300. When the adapter 100 is connected to the base 300, the butt joint 310 on the base 300 pushes the movable member 33, so that the movable member 33 drives the charging gun locking member 31 to switch from the second locked position to the second unlocking position, so that the charging gun 200 can be removed from the mounting cavity 11. And when the charging gun 200 is removed from the mounting cavity 11, by the action of the elastic force of the first resilient member 222, the base locking member 21 is switched from the first unlocking position to the first locked position, so that the adapter 100 is locked in the base 300, reducing the risk of loss caused by the adapter 100 falling off or being stolen.

The above embodiments are only used to illustrate the technical solutions of the present application and are not intended to be limiting, although the application has been described in detail with reference to the above preferred embodiments, a person of ordinary skill in the art should understand that modifications or equivalent substitutions can be made to the technical solutions of the present application without departing from the spirit and scope of the technical solutions of the present application.

What is claimed is:

1. An adapter comprising:
a housing provided with a mounting cavity, the mounting cavity configured for mounting a charging gun; and
a base locking device comprising a base locking member and a movable assembly,
the base locking member movably coupled to the housing, wherein when the base locking member is in a first locking position, the base locking member is lockable to a base, and when the base locking member is in a first unlocking position, the base locking member is unlocked from the base;
the movable assembly is movably disposed in the housing, the movable assembly is capable of engaging the base locking member to limit the base locking member in the first locking position; and
when the charging gun is extended into the mounting cavity, the movable assembly is driven by the charging gun, the movable assembly is configured to be capable of moving away from the base locking member, the base locking member can be switched from the first locked position to the first unlocking position.

2. The adapter of claim 1, wherein the base locking member is rotationally connected to the housing around a first axis of rotation, the base locking member has a first end and a second end disposed on each side of the first axis of rotation, the first end is configured for locking the base;
the movable assembly comprises a bracket, a first resilient member, and a stop member;
the bracket is movably disposed through the housing in a first direction, the bracket is extendable into the mounting cavity at an end proximate the mounting cavity in the first direction;
the first resilient member resiliently presses against the bracket to exert a resilient force on the bracket in the first direction toward the mounting cavity;
the stop member is movably disposed in the housing in a second direction, an end of the stop member in the second direction is movably coupled to the bracket, another end of the stop member along the second direction is extendable between the second end and the housing and configured to rest against the second end, to limit the base locking member in the first locking position; the second direction set at an angle to the first direction; and
the bracket is configured to be capable of being moved in the first direction away from the mounting cavity by the charging gun when the charging gun is extended into the mounting cavity; when the bracket is moved in the first direct, the bracket drives the stop member away from the base locking member in the second direction, and the base locking member is rotatable around the first axis of rotation with respect to the housing, and can be switched from the first locked position to the first unlocking position.

3. The adapter of claim 2, wherein the stop member is provided with a first groove, the first groove extends in a direction of extension, a third end and a fourth end are defined on each end of the first groove, the third end is disposed between the fourth end and the mounting cavity along the first direction, and the fourth end is disposed between the third end and the second end along the second direction;
the stop member is connected to the first groove along the second direction away from the second end and is the stop member is movable within the first groove in the direction of extension of the first groove;
the bracket drives the stop member is configured to be capable of moving from the fourth end to the third end to exit the base locking member along the second direction when the bracket is moved in the first direction toward a side away from the mounting cavity.

4. The adapter of claim 2, wherein an opening is defined by the mounting cavity penetrating through an end of the housing;
the first end is provided proximate to an end of the housing away from the opening;
the first axis of rotation, the first direction and the second direction are perpendicular to each other.

5. The adapter of claim 1, further comprising a charging gun locking device, wherein
the charging gun locking device is movably disposed in the housing, the charging gun locking device is switchable between a second locking position and a second unlocking position, the charging gun locking device locks the charging gun within the mounting cavity when the charging gun locking device is in the second locking position, and the charging gun locking device unlocks the charging gun from the mounting cavity when the charging gun locking device is in the second unlocking position; and
the charging gun locking device is switchable from the second locking position to the second unlocking position when the base is connected to the adapter.

6. The adapter of claim 5, wherein the base is provided with a butt joint;
the charging gun locking device comprises a charging gun locking member, a second resilient member and a movable member;
the charging gun locking member is movably disposed through the housing in a first direction, an end of the charging gun locking member along the first direction proximate to the mounting cavity is extendable into the mounting cavity to lock the charging gun within the mounting cavity when the charging gun locking member is in the second locking position;
the second resilient member resiliently presses against the charging gun locking member to exert a resilient force on the charging gun locking member along the first direction toward the mounting cavity;
the movable member is movably disposed in the housing along a second direction, one end of the movable member along the second direction is movably coupled to the charging gun locking member, and another end of the movable member along the second direction is configured for abutting against the butt joint;
when the base is coupled to the adapter, the movable member is driven by the butt joint, the movable member is configured to be capable of moving in the second direction towards a side proximate to the charging gun locking member,, and to be capable of driving the charging gun locking member in the first direction towards a side away from the mounting cavity, the charging gun can be switched locking member from the second locked position to the second unlocking position.

7. The adapter of claim 6, wherein a second groove is defined on a portion of the charging gun locking member that is outside the mounting cavity, a fifth end and a sixth end are defined on each end of the second groove in the second direction, the sixth end is disposed between an end of the movable member that is away from the charging gun locking member and the fifth end; a cross-sectional area, perpendicular to the second direction, of the second groove gradually increases from the fifth end to the sixth end;
an end of the movable member along the second direction and proximate to the charging gun locking member is movably disposed through the second groove and configured to fit into the second groove;
when the base is connected to the adapter, the butt joint drives one end of the movable member to thread through the second groove toward a side that is proximate to the fifth end, thereby driving the charging gun locking member in the first direction toward a side away from the mounting cavity, the movable member switches the charging gun locking member from the second locking position to the second unlocking position.

8. The adapter of claim 6, wherein the charging gun is provided with a snap-in slot;
in the second locking position, the charging gun locking member is extendable into the snap-in slot to lock the charging gun into the mounting cavity.

9. The adapter of claim 6, wherein an opening is defined by the mounting cavity penetrates through one end of the housing;
the housing is provided with a connecting portion at an end of the housing along the second direction away from the opening, the connecting portion is configured to connect to the base;
an end of the movable member is provided near to the connecting portion, which the end is an end of the movable member away from the charging gun locking member.

10. A charging system comprises:
a charging gun;
a base; and
an adapter comprising:
a housing provided with a mounting cavity, the mounting cavity configured for mounting a charging gun; and
a base locking device comprising a base locking member and a movable assembly,
the base locking member movably coupled to the housing, wherein when the base locking member is in a first locking position, the base locking member is lockable to a base, and when the base locking member is in a first unlocking position, the base locking member is unlocked from the base;
the movable assembly is movably disposed in the housing, the movable assembly is capable of engaging the base locking member to limit the base locking member in the first locking position; and
when the charging gun is extended into the mounting cavity, the movable assembly is driven by the charging gun, the movable assembly is configured to be capable of moving away from the base locking member, the base locking member can be switched from the first locked position to the first unlocking position.

11. The charging system of claim 10, wherein the base locking member is rotationally connected to the housing around a first axis of rotation, the base locking member has a first end and a second end disposed on each side of the first axis of rotation, the first end is configured for locking the base;
the movable assembly comprises a bracket, a first resilient member, and a stop member;
the bracket is movably disposed through the housing in a first direction, the bracket is extendable into the mounting cavity at an end proximate the mounting cavity in the first direction;
the first resilient member resiliently presses against the bracket to exert a resilient force on the bracket in the first direction toward the mounting cavity;
the stop member is movably disposed in the housing in a second direction, an end of the stop member in the second direction is movably coupled to the bracket, another end of the stop member along the second direction is extendable between the second end and the housing and configured to rest against the second end, to limit the base locking member in the first locking position; the second direction set at an angle to the first direction; and
the bracket is configured to be capable of being moved in the first direction away from the mounting cavity by the charging gun when the charging gun is extended into the mounting cavity; when the bracket is moved in the first direct, the bracket drives the stop member away from the base locking member in the second direction, and the base locking member is rotatable around the first axis of rotation with respect to the housing, and can be switched from the first locked position to the first unlocking position.

12. The charging system of claim 11, wherein the stop member is provided with a first groove, the first groove extends in a direction of extension, a third end and a fourth end are defined on each end of the first groove, the third end is disposed between the fourth end and the mounting cavity along the first direction, and the fourth end is disposed between the third end and the second end along the second direction;
the stop member is connected to the first groove along the second direction away from the second end and is the stop member is movable within the first groove in the direction of extension of the first groove;
the bracket drives the stop member is configured to be capable of moving from the fourth end to the third end to exit the base locking member along the second direction when the bracket is moved in the first direction toward a side away from the mounting cavity.

13. The charging system of claim 11, wherein an opening is defined by the mounting cavity penetrating through an end of the housing;
the first end is provided proximate to an end of the housing away from the opening;
the first axis of rotation, the first direction and the second direction are perpendicular to each other.

14. The charging system of claim 10, further comprising a charging gun locking device, wherein
the charging gun locking device is movably disposed in the housing, the charging gun locking device is switchable between a second locking position and a second unlocking position, the charging gun locking device locks the charging gun within the mounting cavity when the charging gun locking device is in the second locking position, and the charging gun locking device unlocks the charging gun from the mounting cavity when the charging gun locking device is in the second unlocking position; and
the charging gun locking device is switchable from the second locking position to the second unlocking position when the base is connected to the adapter.

15. The charging system of claim 14, wherein the base is provided with a butt joint;
the charging gun locking device comprises a charging gun locking member, a second resilient member and a movable member;
the charging gun locking member is movably disposed through the housing in a first direction, an end of the charging gun locking member along the first direction proximate to the mounting cavity is extendable into the mounting cavity to lock the charging gun within the mounting cavity when the charging gun locking member is in the second locking position;
the second resilient member resiliently presses against the charging gun locking member to exert a resilient force on the charging gun locking member along the first direction toward the mounting cavity;
the movable member is movably disposed in the housing along a second direction, one end of the movable member along the second direction is movably coupled to the charging gun locking member, and another end of the movable member along the second direction is configured for abutting against the butt joint;
when the base is coupled to the adapter, the movable member is driven by the butt joint, the movable member is configured to be capable of moving in the second direction towards a side proximate to the charging gun locking member,, and to be capable of driving the charging gun locking member in the first direction towards a side away from the mounting cavity, the charging gun can be switched locking member from the second locked position to the second unlocking position.

16. The charging system of claim 15, wherein a second groove is defined on a portion of the charging gun locking member that is outside the mounting cavity, a fifth end and a sixth end are defined on each end of the second groove in the second direction, the sixth end is disposed between an end of the movable member that is away from the charging gun locking member and the fifth end; a cross-sectional area, perpendicular to the second direction, of the second groove gradually increases from the fifth end to the sixth end;
an end of the movable member along the second direction and proximate to the charging gun locking member is movably disposed through the second groove and configured to fit into the second groove;
when the base is connected to the adapter, the butt joint drives one end of the movable member to thread through the second groove toward a side that is proximate to the fifth end, thereby driving the charging gun locking member in the first direction toward a side away from the mounting cavity, the movable member switches the charging gun locking member from the second locking position to the second unlocking position.

17. The charging system of claim 15, wherein the charging gun is provided with a snap-in slot;
in the second locking position, the charging gun locking member is extendable into the snap-in slot to lock the charging gun into the mounting cavity.

18. The charging system of claim 15, wherein an opening is defined by the mounting cavity penetrates through one end of the housing;
the housing is provided with a connecting portion at an end of the housing along the second direction away from the opening, the connecting portion is configured to connect to the base;
an end of the movable member is provided near to the connecting portion, which the end is an end of the movable member away from the charging gun locking member.
